(19) United States
(12) Patent Application Publication
(10) Pub. No.: US 2025/0200840 A1
(43) Pub. Date: Jun. 19, 2025

(54) DATA ANALYSIS METHOD, ELECTRONIC DEVICE AND STORAGE MEDIUM

(71) Applicant: Beijing Volcano Engine Technology Co., Ltd., Beijing (CN)

(72) Inventors: Xiaokang WEN, Beijing (CN); Chenxi MA, Beijing (CN); Lu LI, Beijing (CN); Danchi FAN, Beijing (CN)

(21) Appl. No.: 18/981,168

(22) Filed: Dec. 13, 2024

(30) Foreign Application Priority Data
Dec. 14, 2023 (CN) 202311723929.2

(51) Int. Cl. G06T 11/20; G06F 9/451

(52) U.S. Cl. CPC G06T 11/206; G06F 9/451

(57) ABSTRACT

A data analysis method, an electronic device and a readable medium are provided The data analysis method includes: displaying a target data page, the target data page being used to display target data; displaying a first intelligent object page in response to a trigger operation on a first intelligent object on the target data page; and displaying a target dashboard page in response to target information entered on the first intelligent object page and used to create a dashboard for the target data. The target dashboard page includes at least one data chart, the at least one data chart is obtained by analyzing the target data based on analysis dimension information, and the analysis dimension information is determined based on a data dimension in the target data.

### CROSS-REFERENCE TO RELATED APPLICATION

The present disclosure claims priority of the Chinese Patent Application No. 202311723929.2 filed on Dec. 14, 2023, the disclosure of which is incorporated herein by reference in its entirety as part of the present application.

### TECHNICAL FIELD

The present disclosure relates to a data analysis method, an electronic and a storage medium.

### BACKGROUND

With continuous growth and diversification of data, data management and analysis become increasingly important. A data dashboard can display visual charts of different service data, to help a user quickly understand and analyze the data.

### SUMMARY

The Summary is to introduce a selection of concepts in a simplified form that are further described below in the Detailed Description. The Summary is neither intended to identify key features or essential features of the claimed subject matter, nor is it intended to be used to limit the scope of the claimed subject matter.

The present disclosure provides a data analysis method, including:
displaying a target data page, wherein the target data page is used to display target data;
displaying a first intelligent object page in response to a trigger operation on a first intelligent object in the target data page; and
displaying a target dashboard page in response to target information entered on the first intelligent object page and used to create a dashboard for the target data, wherein the target dashboard page includes at least one data chart, the at least one data chart is obtained by analyzing the target data based on analysis dimension information, and the analysis dimension information is determined based on a data dimension in the target data.

The present disclosure provides a data analysis apparatus, the data analysis apparatus including:
a first display module, configured to display a target data page, wherein the target data page is used to display target data;
a second display module, configured to display a first intelligent object page in response to a trigger operation on a first intelligent object in the target data page; and
a third display module, configured to display a target dashboard page in response to target information entered on the first intelligent object page and used to create a dashboard for the target data, wherein the target dashboard page includes at least one data chart, the at least one data chart is obtained by analyzing the target data based on analysis dimension information, and the analysis dimension information is determined based on a data dimension in the target data.

The present disclosure provides a non-transient computer-readable storage medium having a computer program stored thereon, the program, when executed by a processing apparatus, implementing the steps of the method of the above.

The present disclosure provides an electronic device, including:
a storage apparatus having a computer program stored thereon; and
a processing apparatus configured to execute the computer program in the storage apparatus to implement the method of the above.

### BRIEF DESCRIPTION OF DRAWINGS

The above and other features, advantages, and aspects of embodiments of the present disclosure become more apparent with reference to the following specific implementations and in conjunction with the accompanying drawings. Throughout the drawings, the same or similar reference numerals denote the same or similar elements. It should be understood that the accompanying drawings are schematic and that parts and elements are not necessarily drawn to scale. In the accompanying drawings:

FIG. 1 is a schematic flowchart of a data analysis method according to an exemplary embodiment;

FIG. 2 is a schematic diagram of a target data page according to an exemplary embodiment;

FIG. 3 is a schematic diagram of a first intelligent object page according to an exemplary embodiment;

FIG. 4 is a schematic diagram of a dashboard page according to an exemplary embodiment;

FIG. 5 is a schematic diagram of another dashboard page according to an exemplary embodiment;

FIG. 6 is a schematic diagram of an exploration panel according to an exemplary embodiment;

FIG. 7 is a schematic diagram of another exploration panel according to an exemplary embodiment;

FIG. 8 is a schematic diagram of a data chart associated with a reset control according to an exemplary embodiment;

FIG. 9 is a block diagram of a data analysis apparatus according to an exemplary embodiment; and

FIG. 10 is a block diagram of an electronic device according to an exemplary embodiment.

### DETAILED DESCRIPTION

Embodiments of the present disclosure are described in more detail below with reference to the accompanying drawings. Although some embodiments of the present disclosure are shown in the accompanying drawings, it should be understood that the present disclosure may be implemented in various forms and should not be construed as being limited to the embodiments set forth herein. Rather, these embodiments are provided for a more thorough and complete understanding of the present disclosure. It should be understood that the accompanying drawings and the embodiments of the present disclosure are only for exemplary purposes and are not intended to limit the scope of protection of the present disclosure.

It should be understood that the various steps described in the method implementations of the present disclosure may be performed in different orders, and/or performed in parallel. Furthermore, additional steps may be included and/or the execution of the illustrated steps may be omitted in the method implementations. The scope of the present disclosure is not limited in this regard.

The terms “include/comprise” used herein and the variations thereof are an open-ended inclusion, namely, “include/comprise but not limited to”. The term “based on” is “at least partially based on”. The term “an embodiment” means “at least one embodiment”. The term “another embodiment” means “at least one another embodiment”. The term “some embodiments” means “at least some embodiments”. The relevant definitions of the other terms will be given in the description below.

It should be noted that concepts such as “first” and “second” mentioned in the present disclosure are only used to distinguish different apparatuses, modules, or units, and are not used to limit the sequence of functions performed by these apparatuses, modules, or units or interdependence.

It should be noted that the modifiers “one” and “a plurality of” mentioned in the present disclosure are illustrative and not restrictive, and those skilled in the art should understand that unless the context clearly indicates otherwise, the modifiers should be understood as “one or more”.

The names of messages or information exchanged between a plurality of apparatuses in the implementations of the present disclosure are used for illustrative purposes only and are not used to limit the scope of these messages or information.

It is understandable that before the technical solutions disclosed in the embodiments of the present disclosure are used, the types, scope of use, usage scenarios, and the like of personal information involved in the present disclosure shall be informed to users and the users' authorization shall be obtained through appropriate means in accordance with relevant laws and regulations.

For example, when receiving an active request from a user, a prompt message is sent to the user to explicitly prompt the user that the operation requested by the user will need to obtain and use the user's personal information. Therefore, the user can voluntarily choose whether to provide personal information to a software or hardware such as an electronic device, an application, a server, or a storage medium that performs an operation of the technical solution of the present disclosure based on the prompt information.

As an optional but non-restrictive implementation, in response to receiving an active request from a user, the manner of sending a prompt message to the user may be, for example, a pop-up window, and the prompt message may be presented in the pop-up window in text. In addition, the pop-up window may also carry a selection control for the user to select “agree” or “disagree” to provide personal information to the electronic device.

It is understandable that the above process of notifying and obtaining the user authorization is only illustrative and does not constitute a limitation on the implementation of the present disclosure. Other manners that comply with relevant laws and regulations may also be applied to the implementation of the present disclosure.

In addition, it is understandable that data involved in the technical solution (including but not limited to the data itself, data acquisition, or data use) shall comply with requirements of corresponding laws and regulations and related provisions.

With continuous growth and diversification of data, data management and analysis become increasingly important. A data dashboard can display visual charts of different service data, to help a user quickly understand and analyze the data from different dimensions. In a sales scenario, for example, a plurality of data charts may be displayed on a dashboard page to help the user understand product sales situation from different dimensions, such as product sales situation in a region each month, product sales situation in each region in a specific month, product sales growth in each region.

A data chart in the dashboard needs to be manually created, and the operation is cumbersome. In particular, when a plurality of data charts are created, a lot of time needs to be consumed, and data chart creation efficiency is low.

In view of this, embodiments of the present disclosure provide a data analysis method and apparatus, a non-transient computer-readable storage medium, and an electronic device to solve the above technical problems.

The following further explains the embodiments of the present disclosure with reference to the accompanying drawings.

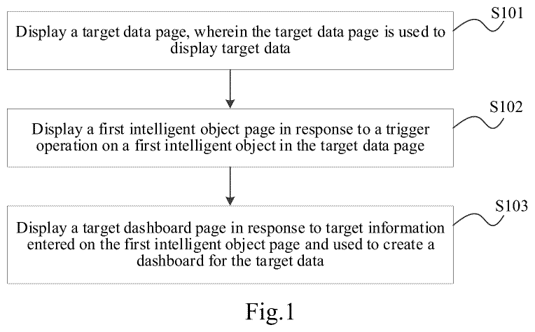

FIG. 1 is a flowchart of a data analysis method according to an exemplary embodiment of the present disclosure. Referring to FIG. 1, the method includes the following steps.

S101: Display a target data page, wherein the target data page is used to display target data.

It should be understood that the target data page may be a page in a data analysis platform that is used to display visual charts of different service data. The data analysis platform is a platform that integrates data access, data processing, data storage, query retrieval, analysis mining, application interfaces, and the like. Different data analysis platforms may be built for different application scenarios, for example, a data analysis platform for product sales. This is not limited in the present disclosure.

S102: Display a first intelligent object page in response to a trigger operation on a first intelligent object in the target data page.

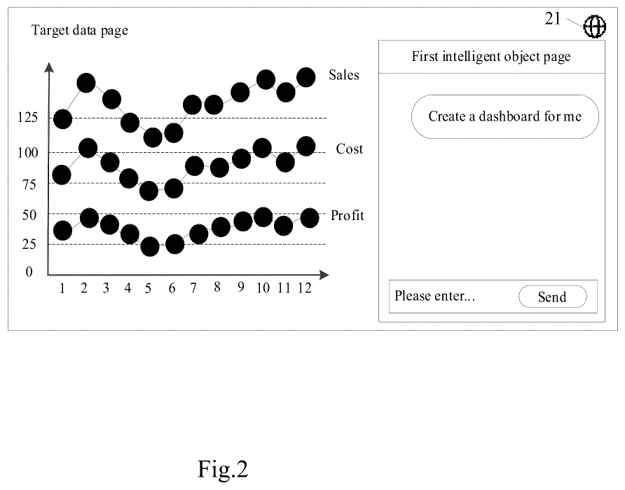

For example, a first intelligent object 21 is displayed on the target data page shown in FIG. 2. A first intelligent object page is displayed by triggering the first intelligent object 21. It should be noted that the intelligent object may be an agent that integrates at least one data generation model. The agent can receive information in a format such as text, voice, or an image that is entered from outside, and process the received text, voice, or image information by using the integrated data generation model, to generate a data chart corresponding to the information or knowledge information related to the data chart.

S103: Display a target dashboard page in response to target information entered on the first intelligent object page and used to create a dashboard for the target data.

The target dashboard page includes at least one data chart, the at least one data chart is obtained by analyzing the target data based on analysis dimension information, and the analysis dimension information is determined based on a data dimension in the target data.

It should be noted that before creating the dashboard, a data set needs to be selected in advance, to determine a source of dashboard data. For example, FIG. 2 shows sales data for a product. This is not limited in the present disclosure.

With the above method, the visual data chart in the dashboard page can be created through a chat by entering the target information on the first intelligent object page, to simplify the configuration operation in the data chart creation process, which is simple to operate, reduces the configuration time, and improves the data chart creation efficiency.

In a possible manner, the displaying a target dashboard page in response to target information entered on the first intelligent object page and used to create a dashboard for the target data may include: displaying first prompt information on the first intelligent object page in response to the target information entered on the first intelligent object page and used to create the dashboard for the target data, wherein the first prompt information includes the analysis dimension information corresponding to a data chart in the dashboard to be created; and displaying the target dashboard page based on the target data and the analysis dimension information in response to a confirmation creation operation on the first intelligent object page.

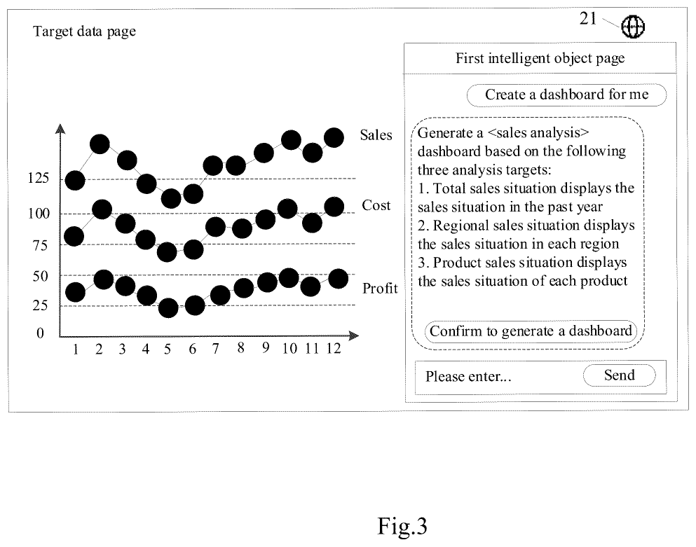

For example, referring to FIG. 3, in response to the target information entered on the first intelligent object page and used to create the dashboard for the target data, for example, “create a dashboard for me”, the first prompt information is displayed on the first intelligent object page, and the first prompt information includes the analysis dimension information corresponding to the data chart in the dashboard to be created, for example, three analysis targets shown in FIG. 3. Then, “confirm to generate a dashboard” may be triggered, to display the target dashboard page based on the target data and the analysis dimension information. In this way, the analysis dimension information corresponding to the data chart in the dashboard to be created can be visually displayed, facilitating the user to understand and confirm to generate the dashboard.

It should be understood that the analysis dimension information shown in FIG. 3 is only used as an example and is specifically analyzed and displayed based on data in an actual service scenario. This is not limited in the present disclosure.

In a possible manner, the displaying a target dashboard page in response to target information entered on the first intelligent object page and used to create a dashboard for the target data may include: displaying an initial dashboard page in response to the target information entered on the first intelligent object page and used to create the dashboard for the target data, wherein a dashboard frame is displayed on the initial dashboard page, the dashboard frame includes at least one chart card, and each chart card corresponds to one data chart to be generated; and displaying the target dashboard page based on the dashboard frame and the target data in response to a confirmation generation operation on the initial dashboard page.

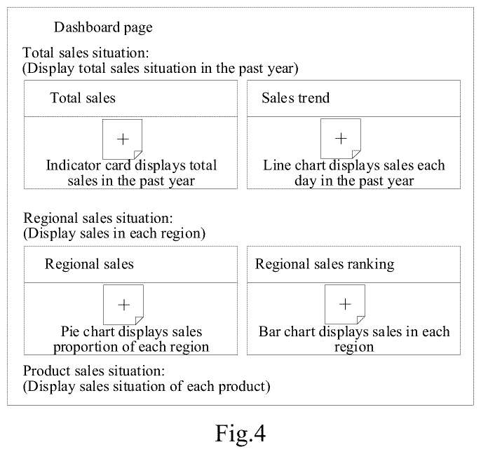

For example, the initial dashboard page shown in FIG. 4 may be displayed in response to the target information “create a dashboard for me” entered as shown in FIG. 3, or the initial dashboard page shown in FIG. 4 may be displayed in response to the target information generated by a trigger operation on “confirm to generate a dashboard” as shown in FIG. 3. This is not limited in the present disclosure.

For example, the sales data of the foregoing product is used to generate the dashboard for example. Referring to FIG. 4, the dashboard frame is displayed on the initial dashboard page. The dashboard frame may include chart cards corresponding to different analysis dimensions, and each chart card corresponds to one data chart to be generated, for example, “a pie chart displays sales proportion of each region”. Then, the target dashboard page may be displayed based on the dashboard frame and the target data in response to a confirmation generation operation on the initial dashboard page, that is, the data chart is generated. In this way, the configuration operation in the data chart creation process can be simplified, which is simple to operate, reduces the configuration time, and improves the data chart creation efficiency.

In a possible manner, the displaying the target dashboard page based on the dashboard frame and the target data in response to the confirmation generation operation on the initial dashboard page may include: when a generation control is displayed on a chart card, displaying the target dashboard page based on the chart card in the dashboard frame and the target data in response to a trigger operation on the generation control in a target chart card, wherein a data chart corresponding to the target chart card in the dashboard frame is displayed on the target dashboard page; or when a second intelligent object page is displayed on the initial dashboard page, displaying the target dashboard page based on the dashboard frame and the target data in response to a one-click generation operation on the second intelligent object page, wherein data charts corresponding to all the chart cards in the dashboard frame are displayed on the target dashboard page.

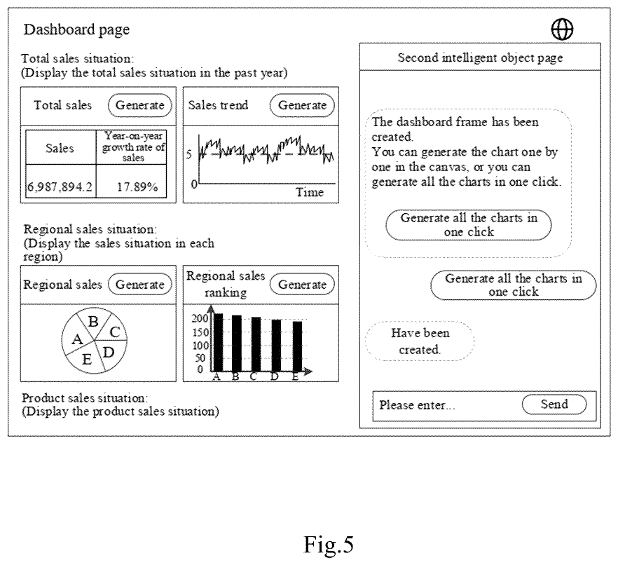

For example, referring to FIG. 5, the data chart corresponding to the target chart card may be generated by triggering the generation control in the target chart card, for example, clicking the generation control of total sales to display the corresponding data chart. Alternatively, the data charts corresponding to all the chart cards may be generated by using the one-click generation control in the second intelligent object page or entering an instruction for one-click generation. FIG. 5 shows a display effect of all data charts generated in one click. In this way, some data charts may be selected for generation as required, or all data charts may be generated, which is simple to operate and has high flexibility.

It should be understood that the target data page and the dashboard page may be a same page, and the first intelligent object page and the second intelligent object page are a same intelligent object page, to refresh data displayed on the page based on a user operation. Alternatively, the target data page and the dashboard page may be different pages, and the dashboard page is jumped to when the dashboard needs to be generated. The first intelligent object page and the second intelligent object page are different intelligent object pages with similar functions. This is not limited in the present disclosure.

In a possible manner, a chart exploration control is displayed in association with each data chart on the target dashboard page, and the data analysis method further includes: displaying an exploration panel in a suspension manner on an upper layer of a target data chart in response to a trigger operation on the chart exploration control corresponding to the target data chart; and updating display of the target data chart or displaying a result of a target operation on the target data chart in the exploration panel based on the target operation in response to the target operation on target data chart in the exploration panel.

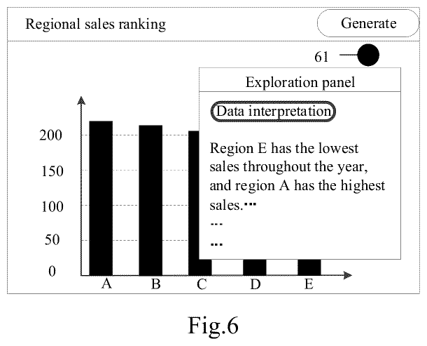

For example, as shown in FIG. 6, the exploration panel is displayed in a suspension manner in response to the trigger operation on the chart exploration control 61 corresponding to the data chart of regional sales ranking. Data operations such as data analysis and data interpretation may be performed on the data chart in the exploration panel. This is not limited in the present disclosure. In addition, the data chart may be updated based on the data operation, or a result of the data operation may be displayed in the exploration panel. In this way, an operation may be performed on the generated data chart on the dashboard page to meet a data processing requirement of the user.

In a possible manner, displaying a result of a target operation in the exploration panel in response to the target operation on the target data chart in the exploration panel may include: displaying a data interpretation result for the target data chart in the exploration panel in response to an interpretation operation on the target data chart in the exploration panel.

For example, referring to FIG. 6, the exploration panel displays a “data interpretation” control. The “data interpretation” control is triggered to display the data interpretation result shown in FIG. 6. The data interpretation result may be determined based on a specific service scenario and the data chart, for example, data interpretation results such as a maximum value, a minimum value, an average value, and an abnormal value of the data chart are output. This is not limited in the present disclosure. In this way, data can be automatically interpreted in real time, facilitating understanding of data content contained in the data chart.

It should be noted that the “data interpretation” control may interpret the data content contained in the data chart by using a pre-trained data interpretation model. For example, a data chart sample with a label may be obtained to train the data interpretation model, wherein the label corresponding to the data chart sample indicates a data interpretation result of the data chart sample. Then, the data chart sample is input into the data interpretation model to obtain a predicted data interpretation result. A loss function value is determined based on the label and the predicted data interpretation information, and then a model parameter of the data interpretation model is updated based on the loss function value until the parameter of the data interpretation model converges or a number of iterations reaches a threshold. In this way, the data chart may be interpreted by using the data interpretation model to obtain the data interpretation result.

In a possible manner, the updating display of the target data chart or displaying a result of a target operation on the target data chart in the exploration panel based on the target operation in response to the target operation on the target data chart in the exploration panel may include: displaying a configuration item in the exploration panel in response to an analysis operation on the target data chart in the exploration panel, wherein the configuration item is used to configure an analysis function for the target data chart; and analyzing the target data chart based on configuration content corresponding to a configuration operation in response to the configuration operation on the target configuration item in the configuration item, and updating the display of the target data chart or displaying a result of the analysis in the exploration panel based on the result of the analysis.

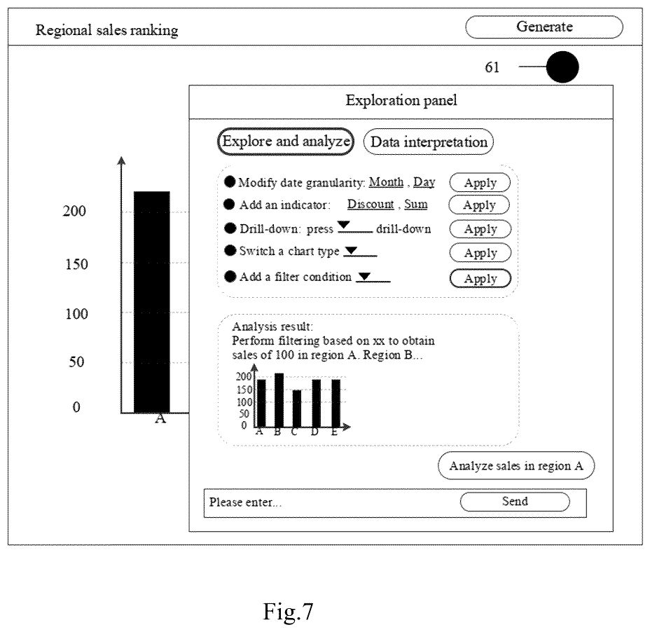

For example, referring to FIG. 7, in response to a trigger operation on “explore and analyze” in the exploration panel, a configuration item for data analysis is displayed. A specific configuration item may be set based on an actual service scenario and a requirement. This is not limited in the present disclosure. In response to the configuration operation on the configuration item, the corresponding configuration content is obtained to perform data analysis on the data chart. An analysis result (the analysis result shown in FIG. 7) may be displayed in the exploration panel, or the data chart may be updated based on the analysis result. This is not limited in the present disclosure. In this way, data can be analyzed in real time, for example, drill-down analysis is performed on the data, to facilitate data analysis on the data chart from another analysis dimension.

It should be noted that the analysis result may display update process information of the data chart shown in FIG. 7, so that an update basis and an update process of the data chart can be visually understood. The analysis result may be generated based on a preset template, for example, an analysis template for a dimension change, an analysis template for an indicator change, an analysis template for modifying a chart type, and then the process information is output by using the corresponding template based on an actual change of the data chart. Alternatively, with reference to the foregoing data interpretation model, the process information is output by using an update process model based on an update change of the data chart, and the like. This is not limited in the present disclosure.

It should be noted that the exploration panel may also have a function of the intelligent object page. Referring to FIG. 7, data analysis may be performed on the data chart based on the entered information. In this way, data analysis can be performed on the visual data chart through a chat, to simplify the data analysis operation and improve the data chart analysis efficiency.

In addition, the intelligent object page may display a page corresponding to the “explore and analyze” control or a page corresponding to the “data interpretation” control by default. This is not limited in the present disclosure. In addition, a display position of the exploration panel may be moved by using a drag operation, or the exploration panel may be enlarged or reduced. This is not limited in the present disclosure. Therefore, a size and a position of the exploration panel can be changed as required.

In a possible manner, a reset control is displayed in association with the target data chart, and the data analysis method further includes: after the display of the target data chart is updated, undoing the update of the display of the target data chart in response to a trigger operation on the reset control.

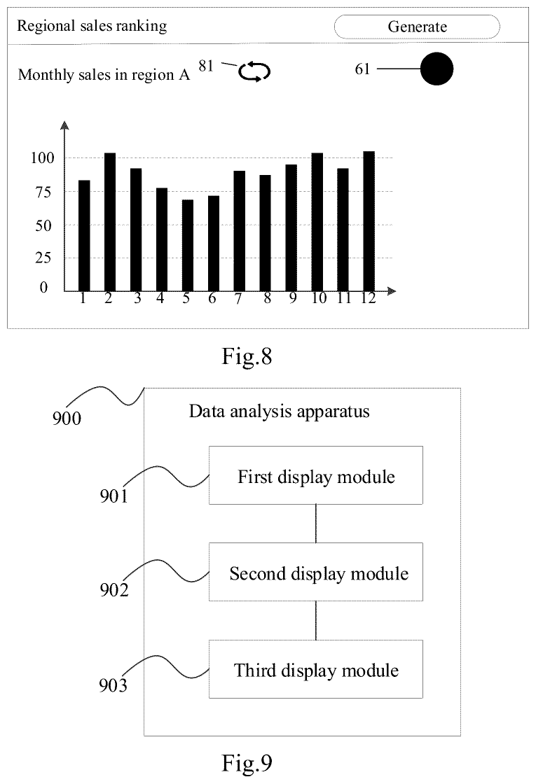

For example, referring to FIG. 8, a reset control 81 is displayed in association with the target data chart. For example, in response to a data analysis operation of “analyze sales in region A” shown in FIG. 7, the data chart is updated to monthly sales situation in region A. In response to the trigger operation on the reset control 81, the update of the display of the target data chart may be undone, that is, the data chart is reset to the data chart before the update. In this way, the data chart before the update can be viewed, or the data chart can be restored to the data chart before the operation in the case of an operation error.

It should be understood that in a case where the data chart is updated a plurality of times, for example, the data chart is updated twice, the reset control 81 is triggered once, the data chart is reset to the data chart updated for the first time. When the reset control 81 is triggered again, the data chart is reset to the initial data chart. Alternatively, when the reset control 81 is triggered, an update list of the data chart is displayed, and the update list displays an identifier of the data chart updated each time, for example, “initial data chart” and “data chart updated for the first time”. A desired data chart may be selected for restoration and display. This is not limited in the present disclosure.

In addition, a restore control may also be displayed. For example, an example in which the data chart is updated twice is illustrated. When the reset control 81 is triggered once, the data chart is reset to the data chart updated for the first time. At this time, when the restore control is triggered once, the data chart can be restored to the data chart updated for the second time. This may be specifically set based on a requirement. This is not limited in the present disclosure. In this way, the data chart can be conveniently switched and displayed as required.

It should be noted that, in the pages shown in FIG. 2 to FIG. 8, content such as a page style, a layout, a menu name, a field name, a control name, a configuration item, entered information, and a displayed data chart is only used as an example and does not constitute a limitation on the solution. The content may be specifically determined based on an actual service scenario and a requirement. For example, a feedback control may be displayed on the intelligent object page, and the user may feedback accuracy of the data chart displayed each time by using the feedback control. A save button also may be displayed to save the data chart etc. This is not limited in the present disclosure.

Based on the same inventive concept, the present disclosure further provides a data analysis apparatus. Referring to FIG. 9, the data analysis apparatus 900 includes:
a first display module 901, configured to display a target data page, wherein the target data page is used to display target data;
a second display module 902, configured to display a first intelligent object page in response to a trigger operation on a first intelligent object in the target data page; and
a third display module 903, configured to display a target dashboard page in response to target information entered on the first intelligent object page and used to create a dashboard for the target data, wherein the target dashboard page includes at least one data chart, the at least one data chart is obtained by analyzing the target data based on analysis dimension information, and the analysis dimension information is determined based on a data dimension in the target data.

With the above apparatus, the visual data chart in the dashboard page can be created through a chat by entering the target information on the first intelligent object page, to simplify the configuration operation in the data chart creation process, which is simple to operate, reduces the configuration time, and improves the data chart creation efficiency.

Optionally, the third display module 903 is configured to:
display first prompt information on the first intelligent object page in response to the target information entered on the first intelligent object page and used to create the dashboard for the target data, wherein the first prompt information includes the analysis dimension information corresponding to a data chart in the dashboard to be created; and
display the target dashboard page based on the target data and the analysis dimension information in response to a confirmation creation operation on the first intelligent object page.

Optionally, the third display module 903 is configured to:
display an initial dashboard page in response to the target information entered on the first intelligent object page and used to create the dashboard for the target data, wherein a dashboard frame is displayed on the initial dashboard page, the dashboard frame includes at least one chart card, and each chart card corresponds to one data chart to be generated; and
display the target dashboard page based on the dashboard frame and the target data in response to a confirmation generation operation on the initial dashboard page.

Optionally, the third display module 903 is configured to:
when a generation control is displayed on a chart card, display the target dashboard page based on the chart card in the dashboard frame and the target data in response to a trigger operation on the generation control in a target chart card, wherein a data chart corresponding to the target chart card in the dashboard frame is displayed on the target dashboard page; or
when a second intelligent object page is displayed on the initial dashboard page, display the target dashboard page based on the dashboard frame and the target data in response to a one-click generation operation on the second intelligent object page, wherein data charts corresponding to all the chart cards in the dashboard frame are displayed on the target dashboard page.

Optionally, a chart exploration control is displayed in association with each data chart on the target dashboard page, and the data analysis apparatus 900 further includes:
a first exploration module, configured to display an exploration panel in a suspension manner on an upper layer of a target data chart in response to a trigger operation on the chart exploration control corresponding to the target data chart; and
a second exploration module, configured to update display of the target data chart or display a result of a target operation on the target data chart in the exploration panel based on the target operation in response to the target operation on the target data chart in the exploration panel.

Optionally, the second exploration module is configured to:
display a data interpretation result for the target data chart in the exploration panel in response to an interpretation operation on the target data chart in the exploration panel.

Optionally, the second exploration module is configured to:
display a configuration item in the exploration panel in response to an analysis operation on the target data chart in the exploration panel, wherein the configuration item is used to configure an analysis function for the target data chart; and
analyze the target data chart based on configuration content corresponding to a configuration operation on the target configuration item in the configuration item in response to the configuration operation on the target configuration item in the configuration item, and update the display of the target data chart or display a result of the analysis in the exploration panel based on a result of the analysis.

Optionally, a reset control is displayed in association with the target data chart, and the data analysis apparatus 900 further includes a reset module, wherein the reset module is configured to:

after the display of the target data chart is updated, undo the update of the display of the target data chart in response to a trigger operation on the reset control.

With respect to the apparatus in the above embodiment, specific manners in which the modules perform operations have been described in detail in the embodiments related to the method and are not described in detail herein.

Based on the same concept, an embodiment of the present disclosure further provides a non-transient computer-readable storage medium having a computer program stored thereon, wherein the program, when executed by a processing apparatus, implements the above data analysis method.

Based on the same concept, an embodiment of the present disclosure further provides an electronic device, including:
a storage apparatus having a computer program stored thereon; and
a processing apparatus configured to execute the computer program in the storage apparatus to implement the above data analysis method.

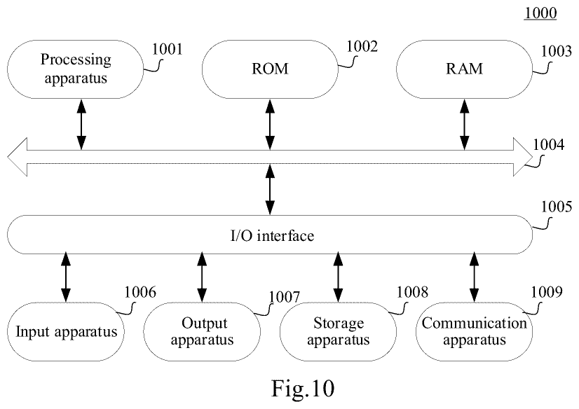

Reference is made to FIG. 10 below, which is a schematic diagram of a structure of an electronic device 1000 suitable for implementing an embodiment of the present disclosure. A terminal device in this embodiment of the present disclosure may include, but is not limited to, mobile terminals such as a mobile phone, a notebook computer, a digital broadcast receiver, a personal digital assistant (PDA), a tablet computer (PAD), a portable multimedia player (PMP), and a vehicle-mounted terminal (such as a vehicle navigation terminal), and fixed terminals such as a digital TV and a desktop computer. The electronic device shown in FIG. 10 is merely an example and shall not impose any limitation on the function and scope of use of the embodiments of the present disclosure.

As shown in FIG. 10, the electronic device 1000 may include a processing apparatus (for example, a central processor, a graphics processor, etc.) 1001 that may perform a variety of appropriate actions and processing in accordance with a program stored in a read-only memory (ROM) 1002 or a program loaded from a storage apparatus 1008 into a random access memory (RAM) 1003. The RAM 1003 further stores various programs and data required for the operation of the electronic device 1000. The processing apparatus 1001, the ROM 1002, and the RAM 1003 are connected to each other through a bus 1004. An input/output (I/O) interface 1005 is also connected to the bus 1004.

Generally, the following apparatuses may be connected to the I/O interface 1005: an input apparatus 1006 including, for example, a touch screen, a touchpad, a keyboard, a mouse, a camera, a microphone, an accelerometer, a gyroscope, and the like; an output apparatus 1007 including, for example, a liquid crystal display (LCD), a speaker, a vibrator, and the like; the storage apparatus 1008 including, for example, a tape and a hard disk; and a communication apparatus 1009. The communication apparatus 1009 may allow the electronic device 1000 to perform wireless or wired communication with other devices to exchange data. Although FIG. 10 shows the electronic device 1000 having various apparatuses, it should be understood that it is not required to implement or have all of the shown apparatuses. It may be an alternative to implement or have more or fewer apparatuses.

In particular, according to an embodiment of the present disclosure, the process described above with reference to the flowcharts may be implemented as a computer software program. For example, this embodiment of the present disclosure includes a computer program product, which includes a computer program carried on a non-transitory computer-readable storage medium, where the computer program includes program code for performing the method shown in the flowchart. In such an embodiment, the computer program may be downloaded from a network through the communication apparatus 1009 and installed, installed from the storage apparatus 1008, or installed from the ROM 1002. When the computer program is executed by the processing apparatus 1001, the above-mentioned functions defined in the method of the embodiment of the present disclosure are performed.

It should be noted that the above computer-readable medium described in the present disclosure may be a computer-readable signal medium, or a computer-readable storage medium, or any combination thereof. The computer-readable storage medium may be, for example but not limited to, electric, magnetic, optical, electromagnetic, infrared, or semiconductor systems, apparatuses, or devices, or any combination thereof. A more specific example of the computer-readable storage medium may include but is not limited to: an electrical connection having one or more wires, a portable computer magnetic disk, a hard disk, a random access memory (RAM), a read-only memory (ROM), an erasable programmable read-only memory (EPROM or flash memory), an optic fiber, a portable compact disk read-only memory (CD-ROM), an optical storage device, a magnetic storage device, or any suitable combination thereof. In the present disclosure, the computer-readable storage medium may be any tangible medium containing or storing a program which may be used by or in combination with an instruction execution system, apparatus, or device. In the present disclosure, the computer-readable signal medium may include a data signal propagated in a baseband or as a part of a carrier, the data signal carrying computer-readable program code. The propagated data signal may be in various forms, including but not limited to an electromagnetic signal, an optical signal, or any suitable combination thereof. The computer-readable signal medium may also be any computer-readable medium other than the computer-readable storage medium. The computer-readable signal medium can send, propagate, or transmit a program used by or in combination with an instruction execution system, apparatus, or device. The program code contained in the computer-readable medium may be transmitted by any suitable medium, including but not limited to: electric wires, optical cables, radio frequency (RF), and the like, or any suitable combination thereof.

In some implementations, any currently known or future-developed network protocol such as a hypertext transfer protocol (HTTP) may be used for communication, and may be connected to digital data communication (for example, a communication network) in any form or medium. Examples of the communication network include a local area network (“LAN”), a wide area network (“WAN”), an internetwork (for example, the Internet), a peer-to-peer network (for example, an ad hoc peer-to-peer network), and any currently known or future-developed network.

The above computer-readable medium may be contained in the above electronic device. The computer-readable medium also may exist independently, without being assembled into the electronic device.

The above computer-readable medium carries one or more programs that, when executed by the electronic device, cause the electronic device to: display a target data page, wherein the target data page is used to display target data; display a first intelligent object page in response to a trigger operation on a first intelligent object in the target data page; and display a target dashboard page in response to target information entered on the first intelligent object page and used to create a dashboard for the target data, wherein the target dashboard page includes at least one data chart, the at least one data chart is obtained by analyzing the target data based on analysis dimension information, and the analysis dimension information is determined based on a data dimension in the target data.

Computer program code for performing operations of the present disclosure may be written in one or more programming languages or a combination thereof, where the programming languages include but are not limited to an object-oriented programming language such as Java, Smalltalk, and C++, and further include conventional procedural programming languages such as “C” language or similar programming languages. The program code may be completely executed on a computer of a user, partially executed on a computer of a user, executed as an independent software package, partially executed on a computer of a user and partially executed on a remote computer, or completely executed on a remote computer or server. In the circumstance involving the remote computer, the remote computer may be connected to the computer of the user over any type of network, including a local area network (LAN) or a wide area network (WAN), or may be connected to an external computer (for example, connected over the Internet using an Internet service provider).

The flowcharts and block diagrams in the accompanying drawings illustrate the possibly implemented architecture, functions, and operations of the system, method, and computer program product according to various embodiments of the present disclosure. In this regard, each block in the flowchart or block diagram may represent a module, program segment, or part of code, and the module, program segment, or part of code contains one or more executable instructions for implementing the specified logical functions. It should also be noted that, in some alternative implementations, the functions marked in the blocks may also occur in an order different from that marked in the accompanying drawings. For example, two blocks shown in succession can actually be executed substantially in parallel, or they can sometimes be executed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations or may be implemented by a combination of dedicated hardware and computer instructions.

The modules involved in the embodiments described in the present disclosure may be implemented by means of software or may be implemented by means of hardware. The name of a module does not constitute a limitation on the module in some cases.

The functions described herein above may be performed at least partially by one or more hardware logic components. For example, without limitation, exemplary types of hardware logic components that may be used include: a field programmable gate array (FPGA), an application-specific integrated circuit (ASIC), an application-specific standard product (ASSP), a system on a chip (SOC), a complex programmable logic device (CPLD), and the like.

In the context of the present disclosure, a machine-readable medium may be a tangible medium that may contain or store a program used by or in combination with an instruction execution system, apparatus, or device. The machine-readable medium may be a machine-readable signal medium or a machine-readable storage medium. The machine-readable medium may include but is not limited to electronic, magnetic, optical, electromagnetic, infrared, or semiconductor systems, apparatuses, or devices, or any suitable combination thereof. A more specific example of the machine-readable storage medium may include an electrical connection based on one or more wires, a portable computer magnetic disk, a hard disk, a random access memory (RAM), a read-only memory (ROM), an erasable programmable read-only memory (EPROM or flash memory), an optic fiber, a portable compact disk read-only memory (CD-ROM), an optical storage device, a magnetic storage device, or any suitable combination thereof.

The foregoing descriptions are merely preferred embodiments of the present disclosure and explanations of the applied technical principles. Persons skilled in the art should understand that the scope of disclosure involved in the present disclosure is not limited to the technical solutions formed by a specific combination of the foregoing technical features, and shall also cover other technical solutions formed by any combination of the foregoing technical features or equivalent features thereof without departing from the foregoing concept of disclosure, for example, the technical solutions formed by replacing the foregoing features with technical features with similar functions disclosed in the present disclosure (but not limited thereto).

In addition, although the various operations are depicted in a specific order, it should be understood as requiring these operations to be performed in the specific order shown or in a sequential order. Under specific circumstances, multitasking and parallel processing may be advantageous. Similarly, although several specific implementation details are included in the foregoing discussions, these details should not be construed as limiting the scope of the present disclosure. Some features that are described in the context of separate embodiments also may be implemented in combination in a single embodiment. In contrast, various features described in a single embodiment also may be implemented in a plurality of embodiments individually or in any suitable sub-combination.

Although the subject matter has been described in a language specific to structural features and/or logical actions of the method, it should be understood that the subject matter defined in the appended claims is not necessarily limited to the specific features or actions described above. In contrast, the specific features and actions described above are merely exemplary forms of implementing the claims. With respect to the apparatus in the above embodiment, specific manners in which the modules perform operations have been described in detail in the embodiments related to the method and are not described in detail herein.

1. A data analysis method, comprising:
displaying a target data page, wherein the target data page is used to display target data;
displaying a first intelligent object page in response to a trigger operation on a first intelligent object in the target data page; and
displaying a target dashboard page in response to target information entered on the first intelligent object page and used to create a dashboard for the target data, wherein the target dashboard page comprises at least one data chart, the at least one data chart is obtained by analyzing the target data based on analysis dimension information, and the analysis dimension information is determined based on a data dimension in the target data.

2. The data analysis method according to claim 1, wherein the displaying a target dashboard page in response to target information entered on the first intelligent object page and used to create a dashboard for the target data comprises:
displaying first prompt information on the first intelligent object page in response to the target information entered on the first intelligent object page and used to create the dashboard for the target data, wherein the first prompt information comprises the analysis dimension information corresponding to a data chart in the dashboard to be created; and
displaying the target dashboard page based on the target data and the analysis dimension information in response to a confirmation creation operation on the first intelligent object page.

3. The data analysis method according to claim 1, wherein the displaying a target dashboard page in response to target information entered on the first intelligent object page and used to create a dashboard for the target data comprises:
displaying an initial dashboard page in response to the target information entered on the first intelligent object page and used to create the dashboard for the target data, wherein a dashboard frame is displayed on the initial dashboard page, the dashboard frame comprises at least one chart card, and each chart card corresponds to one data chart to be generated; and
displaying the target dashboard page based on the dashboard frame and the target data in response to a confirmation generation operation on the initial dashboard page.

4. The data analysis method according to claim 3, wherein the displaying the target dashboard page based on the dashboard frame and the target data in response to a confirmation generation operation on the initial dashboard page comprises:
when a generation control is displayed on the chart card, displaying the target dashboard page based on the chart card in the dashboard frame and the target data in response to a trigger operation on the generation control in a target chart card, wherein a data chart corresponding to the target chart card in the dashboard frame is displayed on the target dashboard page; or
when a second intelligent object page is displayed on the initial dashboard page, displaying the target dashboard page based on the dashboard frame and the target data in response to a one-click generation operation on the second intelligent object page, wherein data charts corresponding to all the chart cards in the dashboard frame are displayed on the target dashboard page.

5. The data analysis method according to claim 1, wherein a chart exploration control is displayed in association with each data chart on the target dashboard page, and the data analysis method further comprises:
displaying an exploration panel in a suspension manner on an upper layer of a target data chart in response to a trigger operation on the chart exploration control corresponding to the target data chart; and
updating display of the target data chart or displaying a result of a target operation on the target data chart in the exploration panel based on the target operation in response to the target operation on the target data chart in the exploration panel.

6. The data analysis method according to claim 5, wherein displaying the result of the target operation in response to the target operation on the target data chart in the exploration panel comprises:
displaying a data interpretation result for the target data chart in the exploration panel in response to an interpretation operation on the target data chart in the exploration panel.

7. The data analysis method according to claim 5, wherein updating display of the target data chart or displaying the result of the target operation on the target data chart in the exploration panel based on the target operation in response to the target operation on the target data chart in the exploration panel comprises:
displaying a configuration item in the exploration panel in response to an analysis operation on the target data chart in the exploration panel, wherein the configuration item is used to configure an analysis function for the target data chart; and
analyzing the target data chart based on configuration content corresponding to a configuration operation on the target configuration item in the configuration item in response to the configuration operation, and updating the display of the target data chart or displaying a result of the analysis in the exploration panel based on the result of the analysis.

8. The data analysis method according to claim 7, wherein a reset control is displayed in association with the target data chart, and the data analysis method further comprises:
after the display of the target data chart is updated, undoing the update of the display of the target data chart in response to a trigger operation on the reset control.

9. The data analysis method according to claim 2, wherein the displaying a target dashboard page in response to target information entered on the first intelligent object page and used to create a dashboard for the target data comprises:
displaying an initial dashboard page in response to the target information entered on the first intelligent object page and used to create the dashboard for the target data, wherein a dashboard frame is displayed on the initial dashboard page, the dashboard frame comprises at least one chart card, and each chart card corresponds to one data chart to be generated; and
displaying the target dashboard page based on the dashboard frame and the target data in response to a confirmation generation operation on the initial dashboard page.

10. The data analysis method according to claim 2, wherein a chart exploration control is displayed in association with each data chart on the target dashboard page, and the data analysis method further comprises:
displaying an exploration panel in a suspension manner on an upper layer of a target data chart in response to a trigger operation on the chart exploration control corresponding to the target data chart; and
updating display of the target data chart or displaying a result of a target operation on the target data chart in the exploration panel based on the target operation in response to the target operation on the target data chart in the exploration panel.

11. The data analysis method according to claim 3, wherein a chart exploration control is displayed in association with each data chart on the target dashboard page, and the data analysis method further comprises:
displaying an exploration panel in a suspension manner on an upper layer of a target data chart in response to a trigger operation on the chart exploration control corresponding to the target data chart; and
updating display of the target data chart or displaying a result of a target operation on the target data chart in the exploration panel based on the target operation in response to the target operation on the target data chart in the exploration panel.

12. The data analysis method according to claim 4, wherein a chart exploration control is displayed in association with each data chart on the target dashboard page, and the data analysis method further comprises:
displaying an exploration panel in a suspension manner on an upper layer of a target data chart in response to a trigger operation on the chart exploration control corresponding to the target data chart; and
updating display of the target data chart or displaying a result of a target operation on the target data chart in the exploration panel based on the target operation in response to the target operation on the target data chart in the exploration panel.

13. An electronic device, comprising:
a storage apparatus, having a computer program stored thereon; and
a processing apparatus, configured to execute the computer program in the storage apparatus to implement a data analysis method, the data analysis method comprising:
displaying a target data page, wherein the target data page is used to display target data;
displaying a first intelligent object page in response to a trigger operation on the first intelligent object in the target data page; and
displaying a target dashboard page in response to target information entered on the first intelligent object page and used to create a dashboard for the target data, wherein the target dashboard page comprises at least one data chart, the at least one data chart is obtained by analyzing the target data based on analysis dimension information, and the analysis dimension information is determined based on a data dimension in the target data.

14. The electronic device according to claim 13, wherein the displaying a target dashboard page in response to target information entered on the first intelligent object page and used to create a dashboard for the target data comprises:
displaying first prompt information on the first intelligent object page in response to the target information entered on the first intelligent object page and used to create the dashboard for the target data, wherein the first prompt information comprises the analysis dimension information corresponding to a data chart in the dashboard to be created; and
displaying the target dashboard page based on the target data and the analysis dimension information in response to a confirmation creation operation on the first intelligent object page.

15. The electronic device according to claim 13, wherein the displaying a target dashboard page in response to target information entered on the first intelligent object page and used to create a dashboard for the target data comprises:
displaying an initial dashboard page in response to the target information entered on the first intelligent object page and used to create the dashboard for the target data, wherein a dashboard frame is displayed on the initial dashboard page, the dashboard frame comprises at least one chart card, and each chart card corresponds to one data chart to be generated; and
displaying the target dashboard page based on the dashboard frame and the target data in response to a confirmation generation operation on the initial dashboard page.

16. The electronic device according to claim 15, wherein the displaying the target dashboard page based on the dashboard frame and the target data in response to a confirmation generation operation on the initial dashboard page comprises:
when a generation control is displayed on the chart card, displaying the target dashboard page based on the chart card in the dashboard frame and the target data in response to a trigger operation on the generation control in a target chart card, wherein a data chart corresponding to the target chart card in the dashboard frame is displayed on the target dashboard page; or
when a second intelligent object page is displayed on the initial dashboard page, displaying the target dashboard page based on the dashboard frame and the target data in response to a one-click generation operation on the second intelligent object page, wherein data charts corresponding to all the chart cards in the dashboard frame are displayed on the target dashboard page.

17. The electronic device according to claim 13, wherein a chart exploration control is displayed in association with each data chart on the target dashboard page, and the data analysis method further comprises:
displaying an exploration panel in a suspension manner on an upper layer of a target data chart in response to a trigger operation on the chart exploration control corresponding to the target data chart; and
updating display of the target data chart or displaying a result of a target operation on the target data chart in the exploration panel based on the target operation in response to the target operation on the target data chart in the exploration panel.

18. The electronic device according to claim 17, wherein displaying the result of the target operation in response to the target operation on the target data chart in the exploration panel comprises:
displaying a data interpretation result for the target data chart in the exploration panel in response to an interpretation operation on the target data chart in the exploration panel.

19. The electronic device according to claim 17, wherein updating display of the target data chart or displaying the result of the target operation on the target data chart in the exploration panel based on the target operation in response to the target operation on the target data chart in the exploration panel comprises:
displaying a configuration item in the exploration panel in response to an analysis operation on the target data chart in the exploration panel, wherein the configuration item is used to configure an analysis function for the target data chart; and
analyzing the target data chart based on configuration content corresponding to a configuration operation on the target configuration item in the configuration item in response to the configuration operation, and updating the display of the target data chart or displaying a result of the analysis in the exploration panel based on the result of the analysis.

20. A non-transient computer-readable storage medium having a computer program stored thereon, wherein the program, when executed by a processing apparatus, implements a data analysis method, the data analysis method comprising:
displaying a target data page, wherein the target data page is used to display target data;
displaying a first intelligent object page in response to a trigger operation on the first intelligent object in the target data page; and
displaying a target dashboard page in response to target information entered on the first intelligent object page and used to create a dashboard for the target data, wherein the target dashboard page comprises at least one data chart, the at least one data chart is obtained by analyzing the target data based on analysis dimension information, and the analysis dimension information is determined based on a data dimension in the target data.
